(19) United States
(12) Patent Application Publication
(10) Pub. No.: US 2026/0045981 A1
(43) Pub. Date: Feb. 12, 2026

(54) METHODS AND DEVICES FOR BEAMFORMING

(71) Applicant: SAMSUNG ELECTRONICS CO., LTD., Suwon-si (KR)

(72) Inventor: Aiguo YAN, San Jose, CA (US)

(21) Appl. No.: 19/294,994

(22) Filed: Aug. 8, 2025

Related U.S. Application Data
(60) Provisional application No. 63/681,633, filed on Aug. 9, 2024.

(51) Int. Cl. H04B 7/0456; H04B 7/0417; H04B 7/0452; H04B 7/06; H04L 25/02

(52) U.S. Cl. CPC H04B 7/0456; H04B 7/0417; H04B 7/0452; H04B 7/0658; H04L 25/0226

(57) ABSTRACT

A method for beamforming is disclosed. The method performed by a beamformee may include receiving, from a beamformer, a sounding packet, computing estimated channel matrices based on the sounding packet, computing singular value decomposition (SVD) based on the estimated channel matrices, computing normalized right singular matrices based on SVD, computing precoding matrices based on a decompression scheme and the normalized right singular matrices, computing diagonal unitary matrices based on a product of the channel matrices and the precoding matrices, computing, during a beamforming phase, modified beamformed channel matrices based on the diagonal unitary matrices, and receiving, from the beamformer, a beamformed data transmission based on the modified beamformed channel matrices.

### CROSS-REFERENCE TO RELATED APPLICATION

The present application claims priority to and the benefit under 35 U.S.C. § 119(e) of U.S. Provisional Application No. 63/681,633, filed on Aug. 9, 2024, entitled “SINGULAR VALUE DECOMPOSITION (SVD)/GMD BASED OPTIMAL TRANSMIT BEAMFORMING (TXBF),” the entire disclosure of which is incorporated by reference herein.

### BACKGROUND

### 1. Field

Aspects of some embodiments relate to wireless communications. For example, aspects of some embodiments of the present disclosure relate to improvements to beamforming.

### 2. Description of the Related Art

As consumer demand for high-speed, reliable wireless connectivity continues to grow, particularly in dense environments, beamforming as emerged as a technology to dynamically direct radio frequency signals toward intended devices.

There are several techniques in beamforming, such as singular value decomposition, channel smoothing, channel estimation, and WiFi beamforming feedback. However, due to the current standards, a beamformer may be limited to send certain matrices (e.g., right singular matrices \tilde{V}(k) and/or \hat{V}(k) of a channel matrix) to a beamformee, such that the beamformee may not learn precoding matrices generated by the beamformer and may not be able to compute an optimal diagonal unitary matrix with accuracy. Furthermore, there may be no efficient smoothing at the beamformee during beamforming under the current standards.

The above information disclosed in this Background section is only for enhancement of understanding of the background and therefore the information discussed in this Background section does not necessarily constitute prior art.

### SUMMARY

One or more aspects of the present disclosure provide a method for beamforming performed by a beamformee that relatively improves the smoothness of channel and the reduction of noise during beamforming.

One or more aspects of the present disclosure also provide a method for beamforming performed by a beamformer that relatively improves the smoothness of channel and may relatively reduce noise during beamforming.

One or more aspects of the present disclosure also provide a beamformee for beamforming that relatively improves the smoothness of channel and relatively reduces noise during beamforming.

Additional aspects will be set forth in part in the description which follows and, in part, will be apparent from the description, or may be learned by practice of the presented embodiments of the disclosure.

According to one or more embodiments of the present disclosure, a method may include receiving, from a beamformer by a beamformee, a sounding packet, computing, by the beamformee, estimated channel matrices H(k) based on the sounding packet, computing, by the beamformee, singular value decomposition (SVD) based on the estimated channel matrices H(k)=U(k)S(k)V^{H}(k), computing, by the beamformee, normalized right singular matrices V̅(k) based on SVD, computing, by the beamformee, precoding matrices \hat{V}(k) based on a decompression scheme and the normalized right singular matrices V̅(k), computing, by the beamformee, diagonal unitary matrices \tilde{D}(k) based on a product of the estimated channel matrices H(k) and the precoding matrices \hat{V}(k), computing, by the beamformee during a beamforming phase, modified beamformed channel matrices \hat{\tilde{H}}_{BF} based on the diagonal unitary matrices \tilde{D}(k), and receiving, by the beamformee, from the beamformer, a beamformed data transmission based on the modified beamformed channel matrices \hat{\tilde{H}}_{BF}.

In one or more embodiments, the method may further include computing, by the beamformee, a filter F based on a product of the estimated channel matrices H(k), the precoding matrices \hat{V}(k), and the diagonal unitary matrices \tilde{D}(k) during a sounding phase.

In one or more embodiments, the method may further include computing, by the beamformee, estimated beamformed channel matrices Ĥ_{BF}(k) during the beamforming phase.

In one or more embodiments, the computing of the modified beamformed channel matrices Ĥ_{BF} may include applying, by the beamformee, the diagonal unitary matrices \tilde{D}(k) and the filter F to the estimated beamformed channel matrices Ĥ_{BF}(k) to generate the modified beamformed channel matrices \hat{\tilde{H}}_{BF}.

In one or more embodiments, the decompression scheme may be determined from among a plurality of predetermined decompression schemes by at least one of the beamformee or the beamformer.

In one or more embodiments, the decompression scheme may be agreed by the beamformer and the beamformee via a message between the beamformer and the beamformee.

In one or more embodiments, the method may further include sending, to the beamformer by the beamformee, compressed feedback of the normalized right singular matrices V̅(k) at a decimation rate lower than, or equal to, 4.

In one or more embodiments, the decimation rate may be 1.

In one or more embodiments, the method may further include sending, to the beamformer by the beamformee, a Multi-User (MU) type compressed beamforming feedback report, where the beamformer may utilize a beamforming protocol that may be different from a MU beamforming protocol.

According to one or more embodiments of the present disclosure, a method may include sending, to a beamformee by a beamformer, a sounding packet, receiving, from the beamformee by the beamformer, compressed feedback of normalized right singular matrices V̅(k), computing, by the beamformer, precoding matrices \hat{V}(k) based on a decompression scheme and the compressed feedback of the normalized right singular matrices V̅(k), where the decompression scheme is agreed by the beamformer and the beamformee via a message between the beamformer and the beamformee, and sending, to the beamformee, by the beamformer, a beamformed data transmission based on the precoding matrices \hat{V}(k).

In one or more embodiments, the decompression scheme may be determined from among a plurality of predetermined decompression schemes by at least one of the beamformee or the beamformer.

In one or more embodiments, the method may further include receiving, from the beamformee by the beamformer, a Multi-User (MU) type compressed beamforming feedback report.

In one or more embodiments, the beamformer may utilize a beamforming protocol that may be different from a MU beamforming protocol.

According to one or more embodiments of the present disclosure, a beamformee may include a processing circuit, the processing circuit being configured to perform receiving, from a beamformer by a beamformee, a sounding packet, computing, by the beamformee, estimated channel matrices H(k) based on the sounding packet, computing, by the beamformee, singular value decomposition (SVD) based on the estimated channel matrices H(k)=U(k)S(k)V^{H}(k), computing, by the beamformee, normalized right singular matrices V̅(k) based on SVD, computing, by the beamformee, precoding matrices \hat{V}(k) based on a decompression scheme and the normalized right singular matrices V̅(k), computing, by the beamformee, diagonal unitary matrices \tilde{D}(k) based on a product of the estimated channel matrices H(k) and the precoding matrices \hat{V}(k), computing, by the beamformee during a beamforming phase, modified beamformed channel matrices \hat{\tilde{H}}_{BF} based on the diagonal unitary matrices \tilde{D}(k), and receiving, by the beamformee, from the beamformer, a beamformed data transmission based on the modified beamformed channel matrices \hat{\tilde{H}}_{BF}.

In one or more embodiments, the processing circuit may further be configured to perform computing, by the beamformee, a filter F based on a product of the estimated channel matrices H(k), the precoding matrices \hat{V}(k), and the diagonal unitary matrices \tilde{D}(k) during a sounding phase.

In one or more embodiments, the processing circuit may further be configured to perform computing, by the beamformee, estimated beamformed channel matrices Ĥ_{BF}(k) during the beamforming phase.

In one or more embodiments, the computing of the modified beamformed channel matrices \hat{\tilde{H}}_{BF} may include applying, by the beamformee, the diagonal unitary matrices \tilde{D}(k) and the filter F to the estimated beamformed channel matrices Ĥ_{BF}(k) to generate the modified beamformed channel matrices \hat{\tilde{H}}_{BF}.

In one or more embodiments, the decompression scheme may be determined from among a plurality of predetermined decompression schemes by at least one of the beamformee or the beamformer.

In one or more embodiments, the decompression scheme may be agreed by the beamformer and the beamformee via a message between the beamformer and the beamformee.

In one or more embodiments, the processing circuit may further be configured to perform sending, to the beamformer by the beamformee, compressed feedback of the normalized right singular matrices V(k) at a decimation rate lower than, or equal to, 4.

In one or more embodiments, the decimation rate may be 1.

In one or more embodiments, the processing circuit may further be configured to perform sending, to the beamformer by the beamformee, a Multi-User (MU) type compressed beamforming feedback report, where the beamformer may utilize a beamforming protocol that may be different from a MU beamforming protocol.

According to one or more embodiments of the present disclosure, the method provides a method for improving beamforming. The method disclosed in the present disclosure may compute diagonal unitary matrices \tilde{D}(k) and a filter F during the sounding phase and further apply the diagonal unitary matrices \tilde{D}(k) and the filter F to estimated beamformed channel matrices Ĥ_{BF}(k) during the beamforming phase, such that the modified estimated beamformed channel matrices \hat{\tilde{H}}_{BF} may be more suitable for data transmission with higher reliability and capacity and reduced noise.

### BRIEF DESCRIPTION OF THE DRAWINGS

The above and other aspects of the present disclosure will be more clearly understood from the following detailed description of the illustrative, non-limiting embodiments with reference to the accompanying drawings.

FIG. 1 is a system diagram including a beamformer and a beamformee, according to one or more embodiments of the present disclosure.

FIG. 2 is a flowchart depicting an example method for beamforming during a sounding phase, according to one or more embodiments of the present disclosure.

FIG. 3 is a flowchart depicting an example method for beamforming during a beamforming phase, according to one or more embodiments of the present disclosure.

FIG. 4 is a flowchart depicting an example method for beamforming performed by a beamformee, according to one or more embodiments of the present disclosure.

FIG. 5 is a flowchart depicting an example method for beamforming performed by a beamformer, according to one or more embodiments of the present disclosure.

FIG. 6 is a block diagram of an electronic device in a network environment, according to one or more embodiments of the present disclosure.

FIG. 7 shows a system including a beamformee and a beamformer access point in communication with each other, according to one or more embodiments of present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the terms “or” and “and/or” include any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

The electronic or electric devices and/or any other relevant devices or components according to embodiments of the present disclosure described herein may be implemented utilizing any suitable hardware, firmware (e.g., an application-specific integrated circuit (ASIC)), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Aspects of some embodiments of the present disclosure relate to wireless communication systems, and for example, to a system and method for enhancing Wi-Fi beamforming performance by relatively improving channel smoothness and reducing noise during the beamforming process.

In general, channel estimation may be very noisy. Channel smoothing filtering may be utilized to improve channel estimation accuracy. Due to constraints in WiFi standards, for example, limitations in what can be passed to the transmitter, or beamformer, it may be difficult to perform channel smoothing filtering with beamformed channels. Thus, embodiments according to the present disclosure may utilize various techniques on the receiver, or beamformee, side to enable channel smoothing filtering.

In particular, in the current standards, SVD-based beamforming technology may be widely used in WiFi (IEEE 802.11) and other communication systems. But, such systems generally have constraints, especially in terms of channel estimation filtering and smoothing. For example, the frequency domain (FD) channel estimation Ĥ(k)=H(k)+w(k) may be corrupted with noise w(k). A low-pass filter may be utilized to improve channel estimation accuracy by exploiting the low-pass (LP) property of the channel matrix H(k). With beamforming (i.e., precoding), the beamformed channel H_{BF}(k)=H(k)\hat{V}(k) may not be guaranteed to have a low-pass property, and applying low-pass filtering/smoothing to the beamformed channel may introduce significant distortion. Using the optimal right singular matrix \hat{V}(k) of the channel matrix H(k), such that estimated beamformed channel matrices \tilde{H}_{BF}(k)=H(k)\tilde{V}(k) may enable a more narrow low-pass property. But, current WiFi standards (e.g., IEEE 802.11ac/ax/be/bn) have constraints in that they may not support feed back of the optimal right singular matrix \tilde{V}(k) or a decimated \tilde{V}(k).

Thus, as described in more detail below, embodiments according to the present disclosure enable calculation of diagonal unitary matrices D(k) such that a filter F based on H(k)\hat{V}(k)D(k) may enable a relatively narrow low pass property. As described in more detail below, with the knowledge of the optimal right singular matrix \tilde{V}(k), a beamformee itself can compute a sequence of diagonal unitary matrices D(k), and a filter F based on H(k)\ddot{V}(k)D(k), where H(k) is the estimated channel from channel sounding, and \hat{V}(k) is the precoding matrices to be used by the beamformer during a beamforming phase. During the beamforming phase, the beamformer applies the diagonal unitary matrices D(k) and the filter F onto an initially estimated beamformed channel Ĥ_{BF}(k), to derive an improved estimated beamformed channel Ĥ_{BF}^{Improve}(k) that is closer to the actual beamformed channel H_{BF}(k) than the initial estimated beamformed channel. Thus, in contrast to systems constrained by the current standards, where the beamformee cannot pass an optimal right singular matrix to the beamformer, as described in more detail below, embodiments according to the present disclosure enable the system to bypass or overcome such constraints, without the beamformee passing the optimal right singular matrix to the beamformee. Additionally, in contrast to alternative systems that may utilize single user beamforming reports, as described in more detail below, some embodiments may utilize multi-user (MU) type beamforming (or compress beamforming) reports from a beamformee to a beamformer, which may enable relatively higher accuracy.

Accordingly, embodiments according to the present disclosure may enable a relatively more consistent and reliable transmission path, enhanced throughput, reduced packet loss, and relatively smoother and robust user experience across varying wireless conditions, by bypassing constraints in current WiFi standards. For example, as described in more detail below, some embodiments according to the present disclosure may make precoding matrices at the beamformer side known to a beamforee so that the beamforee can compute the optimal rotation (diagonal unitary) matrices, thereby enabling relatively higher throughput, reliability, and capacity.

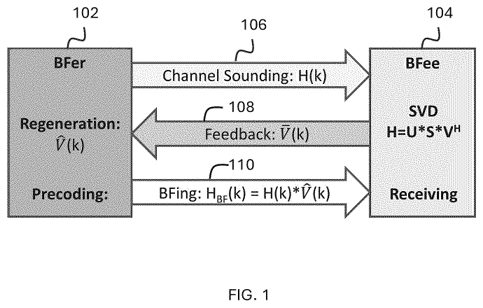

FIG. 1 is a system diagram including a beamformer and a beamformee, in which the present wireless communication systems and methods may be applied, according to one or more embodiments.

A wireless communication system 100 includes a beamformer 102 and a beamformee 104 that may communicate with the beamformer 102. The wireless communication system 100 may be a wireless local area network (WLAN) implemented utilizing any of the IEEE 802.11 standards. The beamformer 102 may communicate with one or more beamformees 104 with which it is associated utilizing a shared local area network protocol and over one or more shared frequency spectrum band. For example, the beamformer 102 and the beamformee 104 may communicate in the 2.4 GHz frequency band, the 5 GHz frequency band, the 6 GHz band, or any combination of these frequency bands. In actual implementations, a WLAN may include one or more access points communicating to a large number of wireless stations. The beamformer 102 may utilize beamforming techniques to focus wireless signals towards the beamformee 104, enhancing signal strength and reducing interference. For example, the beamformer 102 may be a base station (e.g., gNB) or a device that integrates RF components and antenna arrays for beam steering, and the beamformee 104 may be a user equipment (UE), such as smartphones, tablets, and other connected devices. The beamformee 104 may receive the focused radio signals (e.g., focused beam) from the beamformer 102.

Beamforming may be achieved by employing multiple antennas and adjusting the phase and amplitude of signals transmitted from each antenna (e.g., antenna at the beamformer 102) to create a focused beam to improve the signal-to-noise ratio (SNR) of received signals (e.g., at the beamformee 104), which eliminates or reduces interference sources/noise and focuses transmitted signals to specific locations. Therefore, beamforming is a key component to a system (e.g., the wireless communication system 100) with sensor arrays, including Massive Multiple-Input Multiple-Output (MIMO) that utilizes a large number of antennas to serve multiple users simultaneously.

Singular Value Decomposition (SVD) may be utilized in beamforming to improve signal transmission and reception by focusing energy in desired directions. SVD may leverage channel matrices to identify optimal transmit and receive directions, enhancing signal strength and potentially increasing data rates.

In the wireless communication system 100, the channel between the beamformer 102 and the beamformee 104 may be represented by estimated channel matrices H(k) during a sounding phase at operation 106, which may also be represented/computed by H(k)=U(k)S(k)V^{H}(k), where U(k) may be left singular matrices of left singular vectors of H(k), S(k) may be square diagonal matrices of singular values of H(k) on its diagonal, where the singular values may be non-negative real numbers that represent the strength or importance of the different singular vectors; and V^{H}(k) may be the conjugate transpose of another unitary matrix V(k), where V(k) may include the right singular vectors of H(k).

In the standards regarding beamforming at the beamformer 102, H(k)=U(k)S(k)V^{H}(k) may be suitable for channel smoothing which may be widely utilized to improve channel estimate accuracy, where H(k)V(k) may not be suitable for channel smoothing.

Considering different matrices in singular value decomposition (SVD), V(k), \tilde{V}(k), and V̅(k) may be valid SVD matrices for H(k), where H(k)\tilde{V}(k) may also be optimal or suitable for channel smoothing. However, due to the limitations of the current standards, the beamformee 104 may send \hat{V}(k) to the beamformer 102 at operation 108. In addition, \hat{V}(k) may be regenerated/utilized at the beamformer 102 because the beamformer 102 has more freedom comparing with the beamformee 104.

In response to the limitation at the beamformee 104 and lack of information regarding valid SVD matrices (e.g., V(k), \tilde{V}(k), and V̅(k)) to the beamformee 104, one approach is allowing the beamformee 104 to learn all valid SVD matrices, especially \hat{V}(k) generated by the beamformer 102. For example, SVD-based Beamforming technology may be widely utilized in WiFi communications system (IEEE802.11) and other communications systems, which may also introduce limitations to channel estimation filtering/smoothing due to the beamformee 104 lacking information related to valid SVD matrices. At operation 110, during beamforming phase, the beamformer 102 may send precoding matrices \hat{V}(k) to the beamformee 104 for estimating the estimated beamformed channel matrices Ĥ_{BF}(k).

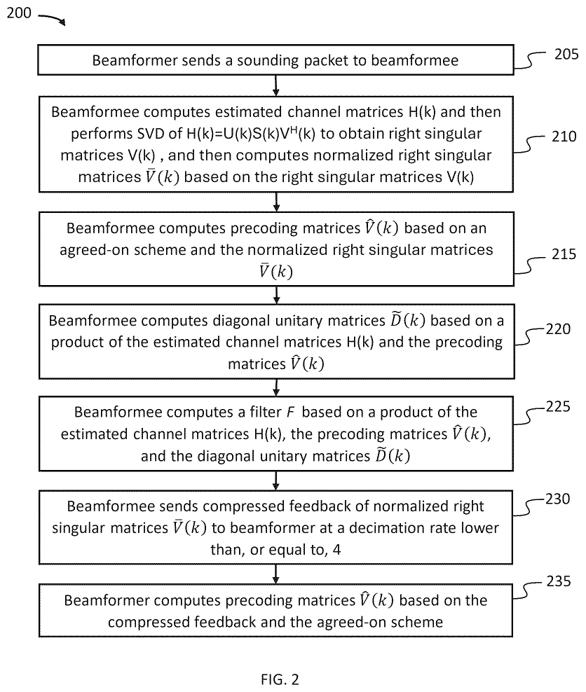

FIG. 2 is a flowchart depicting a method 200 for beamforming during a sounding phase, according to some embodiments of the present disclosure. Although FIG. 2 illustrates various operations in a method for beamforming during the sounding phase, one or more embodiments according to the present disclosure are not limited thereto, and according to one or more embodiments, the method 200 may include additional operations or fewer operations, or the order of operations may vary, unless otherwise stated or implied, without departing from the spirit and scope of embodiments according to the present disclosure.

According to some embodiments, during the sounding phase in the beamforming process, at operation 205, the method 200 may start with a beamformer (e.g., the beamformer 102) sending a sounding packet to a beamformee (e.g., the beamformee 104). For example, the sounding packet may be a data packet utilized to determine the characteristics of the wireless channel between the beamformer and the beamformee, e.g., the data packet may include channel state information (CSI).

Upon receiving the sounding packet, at operation 210, the beamformee may compute/calculate estimated channel matrices H(k) and perform SVD based on the estimated channel matrices H(k) (e.g., H(k)=U(k)S(k)V^{H}(k), where U(k) may be left singular matrices of the estimated channel matrices H(k), and S(k) may be square diagonal matrices of the estimated channel matrices H(k)). For example, the beamformee may utilize the estimated channel matrices H(k) to compute V^{H}(k) and/or information or a matrix associated with H(k). V^{H}(k) is the conjugate transpose of right singular matrices V(k).

At operation 215, the beamformee may compute precoding matrices V(k) based on an agreed-on decompression scheme and SVD (e.g., calculation results of SVD, such as V(k) and/or equivalent S(k)). The agreed-on decompression scheme may be selected from a plurality of predetermined decompression schemes. The predetermined decompression schemes may include one or more of interpolation or an interpolation method or filter, decimation rate, quantization, or any other suitable decompression scheme to enable the beamformer and the beamformee to compute identical (or nearly identical) precoding matrices \hat{V}(k). According to some embodiments, each of the beamformer and the beamformee may store a plurality of predetermined decompression schemes, and at least one of the beamformer or the beamformee may select a decompression scheme from among the predetermined decompression schemes for computing the precoding matrices \hat{V}(k).

According to some embodiments, the selected or agreed-on scheme may be selected based on the conditions of the communication network. For example, if V̅(k) changes slowly according to k, the decimation rate in compression can be relatively bigger and hence the bandwidth of the interpolation filter in decompression be relatively narrower. Similarly, if V̅(k) changes quickly according to k, the decimation rate in compression can be relatively smaller and hence the bandwidth of the interpolation filter in decompression may be relatively smaller. Accordingly, the characteristics or conditions of the communication may be utilized to inform or influence which decompression scheme is selected.

The agreed-on decompression scheme may be agreed by both of the beamformer and the beamformee, so that both of the beamformer and the beamformee may be utilizing the same decompression scheme and/or algorithm for the following computation, e.g., the precoding matrices \hat{V}(k). According to some embodiments, the beamformee and beamformer may store a plurality of predetermined decompression schemes, and the beamformee (or the beamformer) may select a decompression scheme from among the plurality of predetermined schemes, as described above. The selected decompression scheme may be communicated from the beamformee to the beamformer (or vice versa) by way of any suitable communication mechanism, such as a private message or any other message or communication protocol that may be defined.

Because of constraints in the standards that prevent an optimal right singular matrix being passed between the beamformee and the beamformer, embodiments according to the present disclosures may use the selected or agreed-on decompression scheme, the precoding matrices \hat{V}(k) may be computed by both the beamformer and beamformee to ensure that both can obtain the same (or substantially the same) \hat{V}(k).

For example, compression of V̅(k) may be well-defined in the standards at the beamformee side, but computing \hat{V}(k) by decompressing the compressed V̅(k) may not be well defined. Thus, absent the benefit of embodiments according to the present disclosure, the beamformer may have significant freedom to compute the final \hat{V}(k) using a variety of decompression schemes or protocols. In such a scenario, the \hat{V}(k) calculated by the beamformer may be similar to, or very different from \hat{V}(k). By contrast, according to embodiments of the present disclosure, because the beamformer and the beamformee are mutually able to utilize an agreed-on decompression scheme according to the conditions of the network, the beamformer and the beamformee may be able to obtain a \hat{V}(k) that is equal (or approximately equal) to V̅(k).

At operation 220, the beamformee may then compute diagonal unitary matrices \tilde{D}(k) based on a product of the estimated channel matrices H(k) and the precoding matrices \hat{V}(k). According to some embodiments, \tilde{D}(k) may be calculated by minimizing the cost functions according, for example, to the following:

$$J ( \{ \tilde{D} ( k ) \} ) = {\sum }_{k = 1}^{K - 1} {‖ H ( k ) \hat{V} ( k ) \tilde{D} ( k ) - H ( k + 1 ) \hat{V} ( k + 1 ) \tilde{D} ( k + 1 ) ‖}_{F}^{2}$$

Where ∥H∥_{F} is the Frobenius Norm of a matrix of H.

At operation 225, the beamformee may compute a filter F during the sounding phase based on a product of the estimated channel matrices H(k), the precoding matrices \hat{V}(k), and the diagonal unitary matrices \tilde{D}(k). According to some embodiments, the filter F may be a function as follows:

F(x)=IDFT(BWW(DFT(x))),
where x is a sequence such as Ĥ_{BF}(k)\tilde{D}(k), IDFT is an inverse discrete Fourier transformation (DFT), and BWW is a Brick Wall Window.

As another example, the filter F may be a function as follows:

F(x)=IDFT(RectWin(DFT(x))),

where x is a sequence such as Ĥ_{BF}(k)\tilde{D}(k), IDFT is an inverse discrete Fourier transformation (DFT), and RectWin is a Rectangular Window. The width of the window may be chosen such that the difference of RectWin(y) or BWW(y) compared to y=DFT(x) meets a predefined criterion (y is an intermediate variable for concise expression).

At operation 230, the beamformee may send compressed feedback (e.g., compressed feedback associated with the normalized right singular matrices V(k)) to the beamformer at a decimation rate lower than, or equal to, four. For example, the beamformee may send the compressed feedback of the normalized right singular matrices V̅(k) to the beamformer at a decimation rate of one. According to embodiments of the present disclosure, the beamformee may utilize any suitable compression scheme or protocol, for example, as is defined in the standard.

For a given right singular matrix V of right singular vectors (H(k)), the right singular matrix V may be represented as follows:

$$V = ( \begin{matrix}\times & \times & ⋯ & \times \\ \times & \times & ⋯ & \times \\ ⋮ & ⋮ & ⋱ & ⋮ \\ {r}_{M , 1} {e}^{j {θ}_{M , 1}} & {r}_{M , 2} {e}^{j {θ}_{M , 2}} & ⋯ & {r}_{M , N} {e}^{j {θ}_{M , N}}\end{matrix} ) , \times means “ do not care ”$$

The normalized right singular matrix V̅(k) may be represented or calculated according to the following:

$$\begin{matrix}\overline{V} = V ( k ) D , where D \\ = diag ( [ \begin{matrix}{e}^{- j {θ}_{M , 1}} & {e}^{- j {θ}_{M , 2}} & ⋯ & {e}^{- j {θ}_{M , N}} ] )\end{matrix} \\ = ( \begin{matrix}\times & \times & ⋯ & \times \\ \times & \times & ⋯ & \times \\ ⋮ & ⋮ & ⋱ & ⋮ \\ {r}_{M , 1} & {r}_{M , 2} & ⋯ & {r}_{M , N}\end{matrix} ) , last row being real and non - negative .\end{matrix}$$

At operation 235, in response to receiving the compress feedback from the beamformee, the beamformer may compute precoding matrices \hat{V}(k) as described above, for example, with respect to operation 215.

The precoding matrices \hat{V}(k) computed by the beamformer may be the same as the precoding matrices \hat{V}(k) computed by the beamformee due to the agreed-on (or selected) decompression scheme.

Based on the current standards, the beamformee may not be able to directly send optimal right singular matrices \tilde{V}(k) to the beamfomer, therefore, an agreed-on decompression scheme by both of the beamformer and the beamformee (e.g., the selected decompression scheme) may ensure the calculations that are done by the beamformer to be substantially the same as the calculations that are done by the beamformee, e.g., the calculation for the precoding matrices \hat{V}(k), thereby improving the accuracy for computing suitable beamformed channel matrices \tilde{H}_{BF} for data transmission during a beamforming phase.

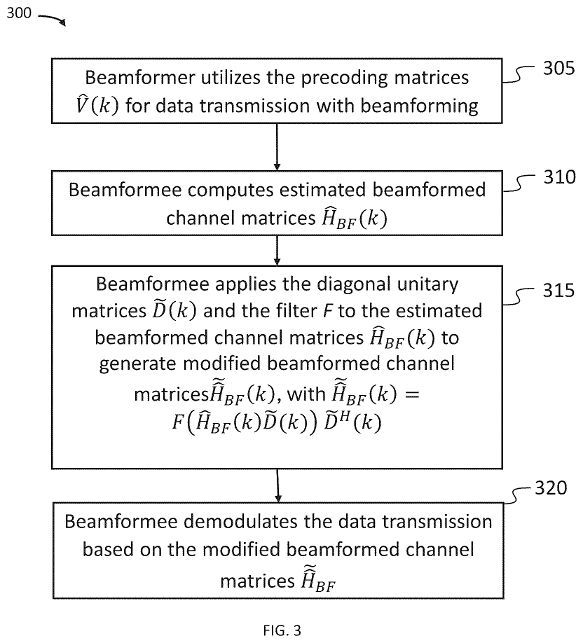

FIG. 3 is a flowchart depicting further details of a method 300 for beamforming during a beamforming phase, according to some embodiments of the present disclosure. Although FIG. 3 illustrates various operations in a method for beamforming during the beamforming phase, one or more embodiments according to the present disclosure are not limited thereto, and according to one or more embodiments, the method 300 may include additional operations or fewer operations, or the order of operations may vary, unless otherwise stated or implied, without departing from the spirit and scope of embodiments according to the present disclosure.

At operation 305, during a beamforming phase in the beamforming process, the beamformer (e.g., the beamformer 102) may utilize the precoding matrices (k) for data transmission with beamforming. At operation 310, the beamfomee (e.g., the beamformee 104) may further compute estimated beamformed channel matrices Ĥ_{BF}(k).

At operation 315, the beamformee may apply the diagonal unitary matrices \tilde{D}(k) and the filter F to the estimated beamformed channel matrices Ĥ_{BF}(k) to generate modified beamformed channel matrices \hat{\tilde{H}}_{BF}. For example, the beamformee may apply the diagonal unitary matrices \tilde{D}(k) and the filter F computed during the sounding phase to the estimated beamformed channel matrices Ĥ_{BF}(k), such that a more suitable estimated beamformed channel matrices for data transmission, e.g., the modified beamformed channel matrices \hat{\tilde{H}}_{BF}, may be obtained, e.g., with higher accuracy and lower noise.

At operation 320, the beamformee may therefore receive the data transmission based on the modified beamformed channel matrices \hat{\tilde{H}}_{BF}.

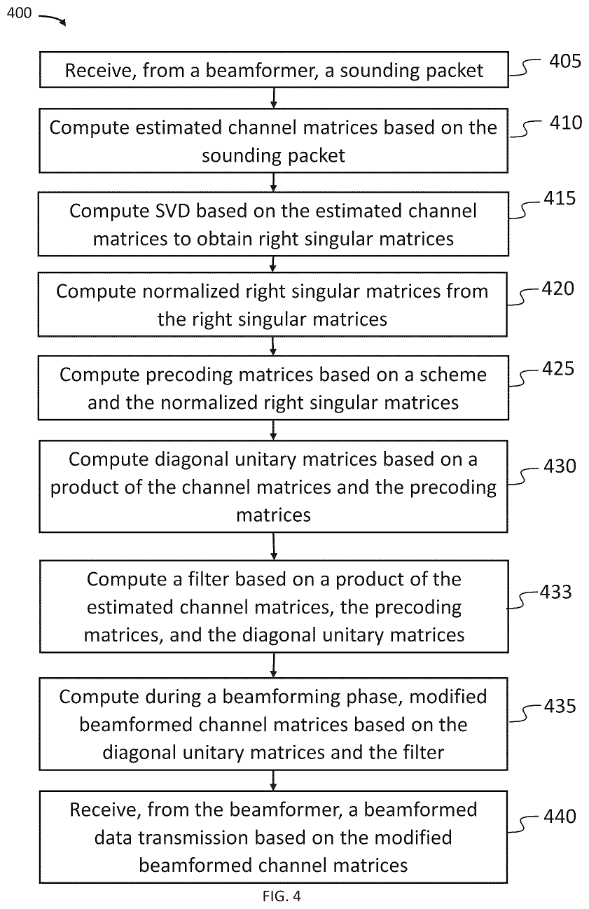

FIG. 4 is a flowchart depicting further details of a method 400 for beamforming performed by a beamformee (e.g., the beamformee 104), according to some embodiments of the present disclosure. Although FIG. 4 illustrates various operations in a method for beamforming performed by the beamformee, one or more embodiments according to the present disclosure are not limited thereto, and according to one or more embodiments, the method 400 may include additional operations or fewer operations, or the order of operations may vary, unless otherwise stated or implied, without departing from the spirit and scope of embodiments according to the present disclosure.

Referring to FIG. 4, at operation 405, a beamformee (e.g., the beamformee 104) may receive, from a beamformer (e.g., the beamformer 102), a sounding packet. As described above, in general, the sounding packet in the context of a Wi-Fi wireless communication system a specially formatted transmission used in Wi-Fi beamforming applications to enable a receiving device to estimate the characteristics of a wireless channel. The receiving device (e.g., the beamforee) may utilize the sounding packet to generate channel state information, which may then be fed back to the transmitter (e.g., the beamformer) to facilitate directional signal transmission.

At operation 410, the beamformee may compute estimated channel matrices H(k) based on the sounding packet. For example, the beamformee may compute/calculate the estimated channel matrices H(k) utilizing an algorithm of H(k)=U(k)S(k)V^{H}(k), where U(k) may be left singular matrices of left singular vectors of H(k), S(k) may be square diagonal matrices of singular values of H(k) on its diagonal, where the singular values may be non-negative real numbers that represent the strength or importance of the different singular vectors; and V^{H}(k) may be the conjugate transpose of another unitary matrix V(k), where V(k) may include the right singular vectors of H(k).

At operation 415, the beamformee may compute singular value decomposition (SVD) based on the estimated channel matrices H(k).

At operation 420, the beamformee may compute normalized right singular matrices V̅(k) based on SVD. For example, the beamformee may compute/calculate the normalized right singular matrices V(k) based on a calculation result of SVD, e.g., the right singular matrices V(k).

At operation 425, the beamformee may compute precoding matrices \hat{V}(k) based on a decompression scheme and the normalized right singular matrices \tilde{V}(k). In one or more embodiments, the decompression scheme may be determined from among a plurality of predetermined decompression schemes by at least one of the beamformee and/or the beamformer. In one or more embodiments, the decompression scheme may be agreed by the beamformer and the beamformee via a message between the beamformer and the beamformee. For example, the message may be a private message.

The precoding matrices (k) may be calculated, for example, as described above with respect to operation 215.

At operation 430, the beamformee may compute diagonal unitary matrices \tilde{D}(k) based on a product of the channel matrices H(k) and the precoding matrices \hat{V}(k). At operation 433, the beamformee may compute a filter based on a product of the estimated channel matrices, the precoding matrices, and the diagonal unitary matrices, for example as described above with respect to operation 225.

At operation 435, the beamformee may compute, during a beamforming phase, modified beamformed channel matrices based on the diagonal unitary matrices. For example, the beamformee may apply the diagonal unitary matrices \tilde{D}(k) (and a filter F) on estimated beamformed channel matrices Ĥ_{BF}(k) to derive improved estimated beamformed channel matrices, according to the following:

$${\tilde{\hat{H}}}_{BF} = {\hat{H}}_{BF}^{Improved} ( k ) = F ( \{ {\hat{H}}_{B F} ( k ) \tilde{D} ( k ) \} ) {\tilde{D}}^{H} ( k )$$

At operation 440, the beamformee may receive (or receive and/or demodulate), from the beamformer, a beamformed data transmission based on the modified beamformed channel matrices \hat{\tilde{H}}_{BF}. For example, the beamformee may receive a beamformed data transmission from the beamformer, the beamformed data transmission being transmitted according to the improved estimated beamformed channel matrices

$${\hat{H}}_{BF}^{Improved} ( k ) ,$$

and the beamformee may demodulate the beamformed data transmission.

In one or more embodiments, the beamformee may further compute a filter F based on a product of the estimated channel matrices H(k), the precoding matrices \hat{V}(k), and the diagonal unitary matrices \tilde{D}(k) during a sounding phase a follows:

$$F is derived based on H ( k ) \hat{V} ( k ) \tilde{D} ( k )$$

In one or more embodiments, the beamformee may further compute estimated beamformed channel matrices Ĥ_{BF}(k) during the beamforming phase.

In one or more embodiments, the computing of the modified beamformed channel matrices \hat{\tilde{H}}_{BF} may include applying, by the beamformee, the diagonal unitary matrices \tilde{D}(k) and the filter F to the estimated beamformed channel matrices \tilde{H}_{BF}(k) to generate the modified beamformed channel matrices A \hat{\tilde{H}}_{BF}.

In one or more embodiments, the beamformee may further send, to the beamformer, compressed feedback of the normalized right singular matrices V̅(k) at a decimation rate lower than, or equal to, 4. For example, the decimation rate may be 1.

In one or more embodiments, the beamformee may further send, to the beamformer, a Multi-User (MU) type compressed beamforming feedback report, where the beamformer may utilize a beamforming protocol that may be different from a MU beamforming protocol. For example, the beamformer may utilize a Single-User (SU) beamforming protocol, a Co-Beamforming protocol, or any other beamforming protocol, and yet the beamformee may still send the MU type compressed beamforming feedback report to the beamformer, e.g., extending the MU type compressed beamforming feedback report. By utilizing an MU type compressed beamforming feedback report, embodiments according to the present disclosure may enable relatively higher accuracy, to any beamforming cases/scenarios, compared to a beamforming report that utilizes a single user (SU) type of beamforming report. According to embodiments of the present disclosure, the beamformee may utilize any suitable compression scheme or protocol, for example, as is defined in the standard. Similarly, the beamformer may utilize any suitable decompression scheme or protocol, for example, as defined in the standard, to decompress the MU type compressed beamforming feedback report.

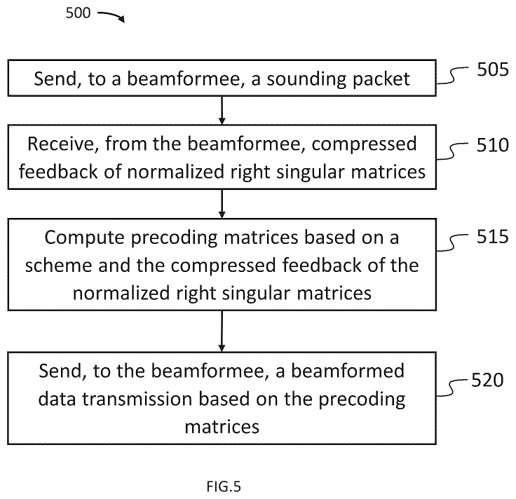

FIG. 5 is a flowchart depicting further details of a method 500 for beamforming performed by a beamformer (e.g., the beamformer 102), according to some embodiments of the present disclosure. Although FIG. 5 illustrates various operations in a method for beamforming performed by the beamformer, one or more embodiments according to the present disclosure are not limited thereto, and according to one or more embodiments, the method 500 may include additional operations or fewer operations, or the order of operations may vary, unless otherwise stated or implied, without departing from the spirit and scope of embodiments according to the present disclosure.

Referring to FIG. 5, at operation 505, a beamformer may send, to a beamformee, a sounding packet.

At operation 510, the beamformer may receive, from the beamformee, compressed feedback of normalized right singular matrices V̅(k).

At operation 515, the beamformer may compute precoding matrices \hat{V}(k) based on a decompression scheme and the compressed feedback of the normalized right singular matrices V̅(k). In one or more embodiments, the decompression scheme may be agreed by the beamformer and the beamformee via a message (e.g., a private message) between the beamformer and the beamformee. In one or more embodiments, the decompression scheme may be determined from among a plurality of predetermined decompression schemes by at least one of the beamformee and/or the beamformer.

At operation 520, the beamformer may send, to the beamformee, a beamformed data transmission based on the precoding matrices V(k).

In one or more embodiments, the beamformer may further receive, from the beamformee, a MU type compressed beamforming feedback report.

In one or more embodiments, the beamformer may utilize a beamforming protocol that may be different from a MU beamforming protocol. For example, the beamformer may utilize a Single-User (SU) beamforming protocol, a Co-Beamforming protocol, or any other beamforming protocol, and yet the beamformee may still send the MU type compressed beamforming feedback report to the beamformer, e.g., extending the MU type compressed beamforming feedback report, which may have higher accuracy, to any beamforming cases/scenarios.

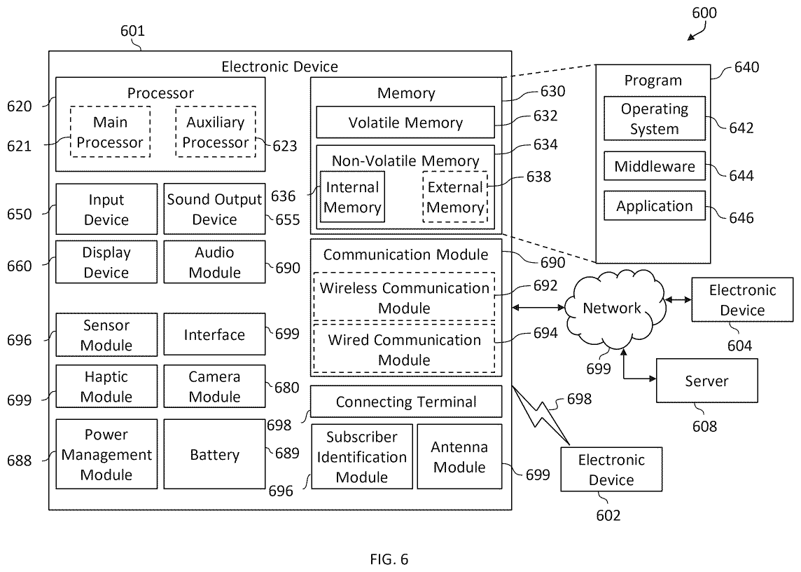

FIG. 6 is a block diagram of an electronic device in a network environment, according to some embodiments of the present disclosure.

Referring to FIG. 6, an electronic device 601 in a network environment 600 may communicate with an electronic device 602 via a first network 698 (e.g., a short-range wireless communication network), or with an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) 696, and/or an antenna module 697. In one embodiment, at least one of the components (e.g., the display device 660 or the camera module 680) may not be provided from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled to the processor 620, and may perform various data processing or computations. For example, the processor 620 may execute instructions to perform methods disclosed in FIGS. 1 to 5.

As at least a part of the data processing or computations, the processor 620 may load a command or data received from another component (e.g., the sensor module 676 or the communication module 690) in volatile memory 632, may process the command or the data stored in the volatile memory 632, and may store resulting data in non-volatile memory 634. The processor 620 may include a main processor 621 (e.g., a central processing unit or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or to execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690), as opposed to the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as separate from, or as a part of, the speaker.

The display device 660 may visually provide information to the outside (e.g., to a user) of the electronic device 601. The display device 660 may include, for example, a display, a hologram device, and/or a projector, and may include control circuitry to control a corresponding one of the display, the hologram device, and/or the projector. The display device 660 may include touch circuitry adapted to detect a touch, and/or may include sensor circuitry (e.g., a pressure sensor) adapted to measure the intensity of force incurred by the touch.

The audio module 670 may convert a sound into an electrical signal and vice versa. The audio module 670 may obtain the sound via the input device 650 and/or may output the sound via the sound output device 655 or a headphone of an external electronic device 602 directly (e.g., wired) or wirelessly coupled to the electronic device 601.

The sensor module 676 may detect an operational state (e.g., power or temperature) of the electronic device 601, and/or an environmental state (e.g., a state of a user) external to the electronic device 601. The sensor module 676 may then generate an electrical signal and/or a data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 677 may support one or more specified protocols to be used for the electronic device 601 to be coupled to the external electronic device 602 directly (e.g., wired) or wirelessly. The interface 677 may include, for example, a high-definition multimedia interface (HDMI), a universal serial bus (USB) interface, a secure digital (SD) card interface, and/or an audio interface.

A connecting terminal 678 may include a connector via which the electronic device 601 may be physically connected to the external electronic device 602. The connecting terminal 678 may include, for example, an HDMI connector, a USB connector, an SD card connector, and/or an audio connector (e.g., a headphone connector).

The haptic module 679 may convert an electrical signal into a mechanical stimulus (e.g., a vibration or a movement) and/or an electrical stimulus, which may be recognized by a user via tactile sensation or kinesthetic sensation. The haptic module 679 may include, for example, a motor, a piezoelectric element, and/or an electrical stimulator.

The camera module 680 may capture a still image and/or moving images. The camera module 680 may include one or more lenses, image sensors, image signal processors, and/or flashes. The power management module 688 may manage power that is supplied to the electronic device 601. The power management module 688 may be implemented as at least a part of, for example, a power management integrated circuit (PMIC).

The battery 689 may supply power to at least one component of the electronic device 601. The battery 689 may include, for example, a primary cell that is not rechargeable, a secondary cell that is rechargeable, and/or a fuel cell.

The communication module 690 may support establishing a direct (e.g., wired) communication channel and/or a wireless communication channel between the electronic device 601 and the external electronic device (e.g., the electronic device 602, the electronic device 604, and/or the server 608), and may support performing communication via the established communication channel. The communication module 690 may include one or more communication processors that are operable independently from the processor 620 (e.g., the AP), and may support a direct (e.g., wired) communication and/or a wireless communication. The communication module 690 may include a wireless communication module 692 (e.g., a cellular communication module, a short-range wireless communication module, and/or a global navigation satellite system (GNSS) communication module) and/or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, and/or a standard of the Infrared Data Association (IrDA)), or via the second network 699 (e.g., a long-range communication network, such as a cellular network, the Internet, and/or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 and/or the second network 699, utilizing subscriber information (e.g., international mobile subscriber identity (IMSI)) stored in the subscriber identification module 696.

The antenna module 697 may transmit or receive a signal and/or power to or from the outside (e.g., the external electronic device) of the electronic device 601. The antenna module 697 may include one or more antennas. The communication module 690 (e.g., the wireless communication module 692) may select at least one of the one or more antennas appropriate for a communication scheme used in the communication network, such as the first network 698 and/or the second network 699. The signal and/or the power may then be transmitted and/or received between the communication module 690 and the external electronic device via the selected at least one antenna.

Commands or data may be transmitted and/or received between the electronic device 601 and the external electronic device 604 via the server 608 coupled to the second network 699. Each of the electronic devices 602 and 604 may be a device of a same type as, or a different type, from the electronic device 601. All or some of operations to be executed at the electronic device 601 may be executed at one or more of the external electronic devices 602 or 604, or server 608. For example, if the electronic device 601 should perform a function or a service automatically, or in response to a request from a user or another device, the electronic device 601, instead of, or in addition to, executing the function or the service, may request the one or more external electronic devices to perform at least a part of the function or the service. The one or more external electronic devices receiving the request may perform the at least a part of the function or the service requested, or an additional function or an additional service related to the request and transfer an outcome of the performing to the electronic device 601. The electronic device 601 may provide the outcome, with or without further processing of the outcome, as at least a part of a reply to the request. To that end, cloud computing, distributed computing, and/or client-server computing technology may be utilized, for example.

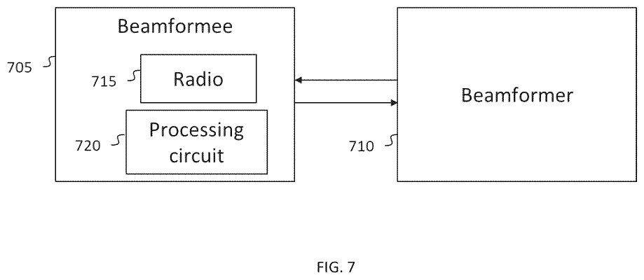

FIG. 7 shows a system including a beamformee 705 and a beamformer 710, in communication with each other. According to some embodiments, the beamformee 705 and the beamformer 710 may be the same as, or similar to, the beamformee 104 and the beamformer 102 described above, respectively, but may be configured to implement one or more of the operations described above, for example, with respect to FIGS. 2-5. The beamformee 705 may include a radio 715 and a processing circuit (or a means for processing) 720, which may perform one or more suitable methods disclosed herein, e.g., the methods illustrated in FIGS. 1 to 4. For example, the processing circuit 720 may receive, via the radio 715, data transmissions from the beamformer 710 based on the modified beamformed channel matrices \hat{\tilde{H}}_{BF} generated based on at least one of the methods disclosed in FIGS. 1 to 4, and the processing circuit 720 may transmit, via the radio 715, signals to the beamformer 710 based on the modified beamformed channel matrices \hat{\tilde{H}}_{BF} generated based on at least one of the methods disclosed in FIGS. 1 to 4. Furthermore, the beamformer 710 may perform one or more suitable methods disclosed herein, e.g., the methods illustrated in FIGS. 1 to 3 and 5.

As described above, embodiments according to the present disclosure enable an enhanced beamforming mechanism that overcomes or circumvents constraints in alternative WiFi beamforming systems as may be defined in the standards. For example, according to some embodiments as described above, both the beamformer and the beamformee may be enabled to compute precoding matrices by utilizing an agreed-upon decompression scheme that is selected from a plurality of predetermined decompression schemes based on the conditions of the wireless network. The selected, or agreed-upon, scheme may be communicated between the beamformee and the beamformer, such that they can mutually compute the precoding matrices using the same decompression scheme, thereby avoiding the beamformer utilizing a different decompression scheme which may result in the precoding matrices being significantly different from the result of the beamformee.

Embodiments of the subject matter and the operations described in this specification may be implemented in digital electronic circuitry, or in computer software, firmware, and/or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, and/or to control the operation of data-processing apparatus. Alternatively or additionally, the program instructions can be encoded on an artificially-generated propagated signal, e.g., a machine-generated electrical, optical, and/or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, and/or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices and/or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations may be depicted in the drawings in a particular order, this should not be understood as requiring that such operations be performed in the particular order shown or in any sequential order, or that all illustrated operations be performed, to achieve desirable results. In certain circumstances, multitasking and parallel processing may be advantageous or suitable. Moreover, the separation of various system components in the embodiments described above should not be understood as requiring such separation in all embodiments, and it should be understood that the described program components and systems can generally be integrated together in a single software product or packaged into multiple software products.

Thus, aspects of some embodiments of the present disclosure have been described herein. Other embodiments are within the scope of the following claims and their equivalents. In some cases, the actions set forth in the claims may be performed in a different order and still achieve desirable or desired results. Additionally, the processes depicted in the accompanying figures do not necessarily require the particular order shown, or sequential order, to achieve desirable or desired results. In certain implementations, multitasking and parallel processing may be advantageous, suitable or desirable.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims, with functional equivalents thereof to be included therein.

What is claimed is:

1. A method comprising:
receiving, from a beamformer by a beamformee, a sounding packet;
computing, by the beamformee, precoding matrices based on a selected decompression scheme from among a plurality of predetermined compression schemes and the sounding packet;
computing, by the beamformee, diagonal unitary matrices based on a product of estimated channel matrices and the precoding matrices;
computing, by the beamformee during a beamforming phase, modified beamformed channel matrices based on the diagonal unitary matrices; and
receiving, by the beamformee, from the beamformer, a beamformed data transmission based on the modified beamformed channel matrices.

2. The method of claim 1, wherein computing the precoding matrices further comprises:
computing, by the beamformee, the estimated channel matrices based on the sounding packet;
computing, by the beamformee, singular value decomposition (SVD) based on the estimated channel matrices;
computing, by the beamformee, normalized right singular matrices based on the SVD; and
computing, by the beamformee, the precoding matrices based on the selected decompression scheme and the normalized right singular matrices.

3. The method of claim 2, further comprising:
sending, to the beamformer by the beamformee, compressed feedback of the normalized right singular matrices at a decimation rate lower than, or equal to, 4.

4. The method of claim 3, wherein the decimation rate is 1.

5. The method of claim 1, further comprising:
computing, by the beamformee, a filter based on a product of the estimated channel matrices, the precoding matrices, and the diagonal unitary matrices during a sounding phase.

6. The method of claim 5, further comprising:
computing, by the beamformee, estimated beamformed channel matrices during the beamforming phase.

7. The method of claim 6, wherein the computing of the modified beamformed channel matrices comprises:
applying, by the beamformee, the diagonal unitary matrices and the filter to the estimated beamformed channel matrices to generate the modified beamformed channel matrices.

8. The method of claim 1, wherein the decompression scheme is selected from among the plurality of predetermined decompression schemes by at least one of the beamformee or the beamformer.

9. The method of claim 1, wherein the decompression scheme is agreed by the beamformer and the beamformee via a message between the beamformer and the beamformee.

10. The method of claim 1, further comprising:
sending, to the beamformer by the beamformee, a Multi-User (MU) type compressed beamforming feedback report, wherein the beamformer utilizes a beamforming protocol that is different from a MU beamforming protocol.

11. A method comprising:
sending, to a beamformee by a beamformer, a sounding packet;
receiving, from the beamformee by the beamformer, compressed feedback of normalized right singular matrices;
computing, by the beamformer, precoding matrices based on a decompression scheme and the compressed feedback of the normalized right singular matrices, wherein the decompression scheme is agreed by the beamformer and the beamformee via a message between the beamformer and the beamformee; and
sending, to the beamformee, by the beamformer, a beamformed data transmission based on the precoding matrices.

12. The method of claim 11, wherein the decompression scheme is determined from among a plurality of predetermined decompression schemes by at least one of the beamformee or the beamformer.

13. The method of claim 11, further comprising:
receiving, from the beamformee by the beamformer, a Multi-User (MU) type compressed beamforming feedback report.

14. The method of claim 13, wherein the beamformer utilizes a beamforming protocol that is different from a MU beamforming protocol.

15. A beamformee comprising a processing circuit, the processing circuit being configured to perform:
receiving, from a beamformer, a sounding packet;
computing precoding matrices based on a selected decompression scheme from among a plurality of predetermined compression schemes and the sounding packet;
computing diagonal unitary matrices based on a product of estimated channel matrices and the precoding matrices;
computing, during a beamforming phase, modified beamformed channel matrices based on the diagonal unitary matrices; and
receiving, from the beamformer, a beamformed data transmission based on the modified beamformed channel matrices.

16. The beamformee of claim 15, wherein computing the precoding matrices further comprises:
computing the estimated channel matrices based on the sounding packet;
computing singular value decomposition (SVD) based on the estimated channel matrices; and
computing normalized right singular matrices based on the SVD; and
computing the precoding matrices based on the decompression scheme and the normalized right singular matrices.

17. The beamformee of claim 16, wherein the processing circuit is further configured to perform:
sending, to the beamformer, compressed feedback of the normalized right singular matrices at a decimation rate lower than, or equal to, 4.

18. The beamformee of claim 17, wherein the decimation rate is 1.

19. The beamformee of claim 15, wherein the processing circuit is further configured to perform:
computing a filter based on a product of the estimated channel matrices, the precoding matrices, and the diagonal unitary matrices during a sounding phase.

20. The beamformee of claim 19, wherein the processing circuit is further configured to perform:
computing estimated beamformed channel matrices during the beamforming phase.

21. The beamformee of claim 20, wherein the computing of the modified beamformed channel matrices comprises:
applying the diagonal unitary matrices and the filter to the estimated beamformed channel matrices to generate the modified beamformed channel matrices.

22. The beamformee of claim 15, wherein the decompression scheme is determined from among the plurality of predetermined decompression schemes by at least one of the beamformee or the beamformer.

23. The beamformee of claim 15, wherein the decompression scheme is agreed by the beamformer and the beamformee via a message between the beamformer and the beamformee.

24. The beamformee of claim 15, wherein the processing circuit is further configured to perform:
sending, to the beamformer, a Multi-User (MU) type compressed beamforming report, wherein the beamformer utilizes a beamforming protocol that is different from a MU beamforming protocol.
